(19) United States
(12) Patent Application Publication
(10) Pub. No.: US 2003/0194994 A1
(43) Pub. Date: Oct. 16, 2003

(54) Method for preventing call forwarding in a group call

(76) Inventor: Per Svedberg, Goteborg (SE)

Correspondence Address: JENKENS & GILCHRIST, P.C., 3200 Fountain Place, 1445 Ross Avenue, Dallas, TX, 75202-2799, US

(21) Appl. No.: 10/121,238

(22) Filed: Apr. 11, 2002

(51) Int. Cl. H04M 3/42

(52) U.S. Cl. 455/417; 455/445

(57) ABSTRACT

In accordance with a preferred embodiment of the present invention, a method for preventing call forwarding in group calls in a mobile network is provided, whereby a redirection counter in an Initial Address Message (IAM) is assigned a predetermined value that causes the network to disconnect a party to a group call if, for example, call forwarding is being used by that party's phone.

### BACKGROUND OF THE INVENTION

1. Technical Field of the Invention

The present invention relates in general to the telecommunications field and, in particular, to a method for preventing, for example, unwanted voice mail announcements in group calls placed within Public Land Mobile Networks (PLMNs).

2. Description of Related Art

An important requirement imposed when group calls are to be set up automatically in mobile networks is that no voice mail announcements may be made during the group calls. In a Global System for Mobile Communications (GSM) network, the originator of a group call can receive a backward notification which indicates that call forwarding has been used by one or more of the parties in the group call (e.g., call forwarding to a voice mail system). However, no such notification is provided for group call originators in other mobile phone networks, such as for example, Digital-Advanced Mobile Phone System (D-AMPS) type networks.

The existing state-of-the-art mobile communication systems provide a number of solutions to this problem related to call forwarding. For example, one such solution is for a network operator to permanently switch off call forwarding for those subscribers that might form part of a group call. However, these subscribers are thus never able to use call forwarding, which is an undesirable solution because call forwarding is a standard feature provided in PLMNs.

Another existing solution is to provide mobile network equipment that supports the use of dual subscriptions, whereby one of the two subscriptions can be dedicated for group calls. This group call subscription can have all call forwarding functions disabled. As such, this solution could be acceptable in some cases. However, the use of dual subscriptions can conflict with fraud detection systems in the mobile networks, because the mobile equipment can change subscribers very rapidly.

Still another existing solution to this call forwarding problem is that by directly interacting with a network Home Location Register (HLR), a group call originator can switch off call forwarding for the terminating parties. For example, an originating party can access the HLR and determine if a wanted party's phone is detached or otherwise unreachable, and if so, switch off call forwarding for that party. Also, an originating party can switch off call forwarding for a wanted party's phone that is busy or does not answer. However, a significant problem with this approach is that passwords would have to be provided for accessing the HLR, which can diminish the security of the network. Another significant problem with this approach is that if someone other than the originating party calls the terminating party after call forwarding has been switched off, that call can reach the wrong subscriber. Still another problem is created if the originating party fails to reset the call forwarding features in the HLR after the group call is completed. Furthermore, if there is no other need for originating party interaction with the HLR, then this access interface would have to be developed exclusively for the call forwarding prevention feature.

Finally, as mentioned earlier, for certain networks (e.g., GSM networks), a group call originator can detect backward notifications for call forwarding and add only those parties to the group call that have not enabled call forwarding. However, a significant problem with using the backward notification function for call forwarding, is that backward notification is not supported by certain networks (e.g., D-AMPS networks). Nevertheless, as described in detail below, the present invention successfully resolves the above-described problems and other related problems.

### SUMMARY OF THE INVENTION

In accordance with a preferred embodiment of the present invention, a method for preventing call forwarding in group calls in a mobile network is provided, whereby a redirection counter in an Initial Address Message (IAM) is assigned a predetermined value that causes the network to disconnect a party to a group call if, for example, call forwarding is being used by that party's phone.

An important technical advantage of the present invention is that voice mail or similar announcements can be prevented during group calls in mobile networks.

Another important technical advantage of the present invention is that a method is provided to ensure that no party's call is forwarded during a group call.

Still another important technical advantage of the present invention is that a method is provided for a network to disconnect a party from a group call if that party's call is forwarded. Consequently, no complex application logic needs to be implemented to detect call forwarding.

Yet another important technical advantage of the present invention is that a method is provided for preventing call forwarding for a party in a group call, which can be implemented in Signaling System #7 (SS7) type networks that do not support backward notifications of call forwarding.

In one embodiment of the invention, There is provided a method for preventing call redirecting in a mobile communications network. First, a predetermined redirection threshold is assigned, and it is determined, prior to establishing a call in said mobile communications network, that call redirecting should not be permitted. A particular value is then assigned to a redirection counter associated with the call in response to the determination that call redirecting should not be permitted. A determination of whether the call has been redirected during a setup of the call is made, and the particular value of the redirection counter is compared to the predetermined threshold if the call has been redirected. Finally, the call is terminated in response to the comparison of the particular value and the predetermined threshold.

In another embodiment of the invention, there is provided a system for preventing call redirecting in a mobile communications network. The system includes a node for storing a redirection count threshold, and at least one mobile switching center. The mobile switching center operates to assign a selected value to a redirection counter associated with a call in response to a determination that call redirecting should not be allowed for the call. Next, it is determined whether the call is redirected during a setup of the call, and the selected value of the redirection counter is compared to the redirection count threshold. Finally, the call is terminated in response to said comparison.

### BRIEF DESCRIPTION OF THE DRAWINGS

A more complete understanding of the method and apparatus of the present invention may be had by reference to the following detailed description when taken in conjunction with the accompanying drawing wherein:

FIG. 1 is a block diagram of an exemplary mobile communication network, which can be used to implement a preferred embodiment of the present invention; and

FIG. 2 is a flow diagram of a process for preventing call redirecting in accordance with another embodiment of the present invention.

### DETAILED DESCRIPTION OF THE DRAWINGS

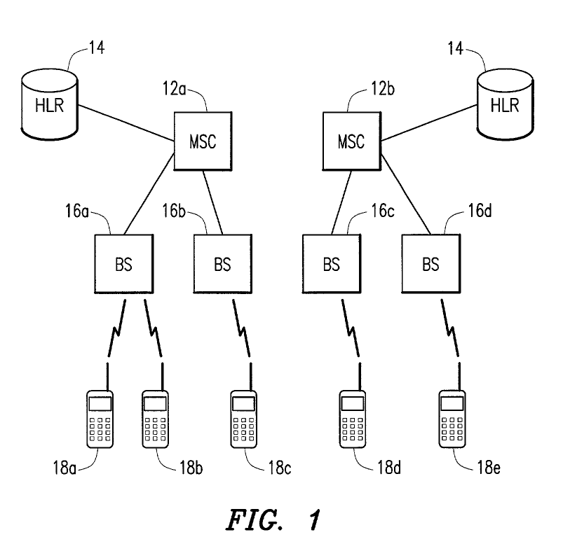

The preferred embodiment of the present invention and its advantages are best understood by referring to FIG. 1 of the drawings.

Essentially, in accordance with a preferred embodiment of the present invention, a method for preventing call forwarding in group calls in a mobile network is provided, whereby a redirection counter in an Initial Address Message (IAM) is assigned a predetermined value that causes the network to disconnect a party to a group call if, for example, call forwarding is being used by that party's phone. In this way, for example, voice mail announcements can be prevented from being made during a group call.

Specifically, FIG. 1 is a block diagram of an exemplary mobile communication network 10, which can be used to implement a preferred embodiment of the present invention. For example, exemplary network 10 can be a D-AMPS network. However, the present invention is not limited to D-AMPS networks and can include other types of mobile networks, such as for example, any SS7 network or similar type of network.

Referring to FIG. 1, exemplary network 10 includes a plurality of Mobile Services Switching Centers (MSCs) 12a-b, an HLR 14 connected to each MSC 12a-b, a plurality of Base Stations (BSs) 16a-d connected to the MSCs 12, and a plurality of Mobile Stations (MSs) 18a-e. The MSs 18a-e are connected to Radio Base Station (RBS) components of the BSs 16a-d via respective radio air interfaces. Notably, although only four BSs 16, five MSs 18, and two MSCs 12 are shown for illustrative purposes, a typical network such as network 10 can include more than four BSs, more than five MSs, and more than two MSCs 12.

A gateway function in at least one MSC 12 provides an interface between network 10 and other networks, such as a Public Switched Telephone Network (PSTN) or another PLMN. A BS site can serve one or more cells. Each HLR 14 contains data about all network subscribers, their services and location. In larger networks, HLRs are typically separate nodes. In smaller networks, HLRs can be integrated with the MSC.

For this exemplary embodiment, an SS7 network is used for signalling between the MSC 12 and HLR 14. In particular, a redirection counter (e.g., Octet 2) in the Redirection Information part of an IAM is used so that the SS7 network can disconnect a specific call within a group call, if call forwarding happens to occur. In particular, by assigning a redirection counter a sufficiently high value in connection with an attempt to set up a group call, the network itself will disconnect the call if call forward occurs. In this way, the redirection counter in an IAM is used to avoid call forwarding loops (e.g., when a call is being forwarded from one number to another in an endless loop).

In a GSM network, the redirection counter keeps track of how many times a call has been redirected. In other words, the redirection counter (Octet 2) in an IAM indicates the number of times a call has been redirected, and the reason for each such redirection. Normally, a limit of 5 re-directions is recommended. So, in accordance with the teachings of the present invention, by setting the redirection counter to a value of 5 in the case of a group call within a GSM network, a network switch is instructed not to allow any more re-directions, and to terminate that call if another (6^{th}) redirection occurs.

Preferably, for most PLMNs using an SS7 network for signalling during the setup of a group call, the redirection counter in an IAM is used to limit the re-directions for any call in the group to only one redirection. If a single redirection occurs for any member of such a group call, a network switch in an MSC 12 involved in the call can disconnect that call. For example, if a group call is originated from a first mobile station 18a and the call group includes a second mobile station 18d that has a call forwarding feature activated, either the originating MSC 12a (i.e., the MSC 12 that serves the MS 18 that originated the group call) or the serving MSC 12b (i.e., the MSC 12 that serves the MS 18 that has a call forwarding feature activated) will disconnect the MS 18d depending on which type of call forwarding has occurred. If “call forwarding unconditional” (CFU) is active, then the originating MSC 12a will disconnect the MS 18d, and if “call forwarding busy” (CFB) or “call forwarding no reply” (CFNR) is active, the serving MSC 12b will disconnect the MS 18d. As will be understood by those of ordinary skill in the art, the originating MSC 12 and the serving MSC 12 can be one and the same (e.g., if the call group includes a third MS 18c that has a call forwarding feature activated and that is served by the same MSC 12a as the MS 18a that originates the group call). In this way, no members of the group call will be forwarded to a second number. Advantageously, the decision to disconnect a call can be made by the network and not by an application. In this way, an application is not required to implement complex logic in order to determine that call forwarding has occurred.

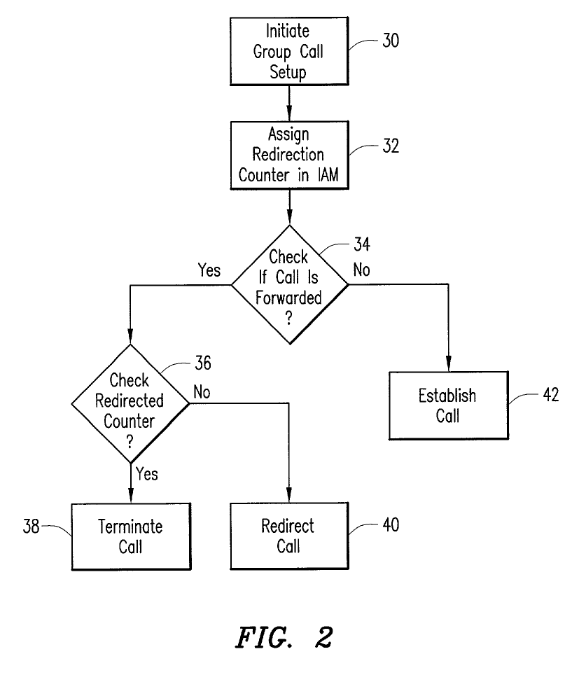

Referring now to FIG. 2, there is shown a flow diagram of a process for preventing call redirecting in accordance with a preferred embodiment of the present invention. Initially, at step 30, a group call setup procedure is initiated either manually or by an application capable of establishing group calls. Generally, the group call to be established involves an initiating station and a plurality of called stations.

At step 32, a preselected value is assigned to a redirection counter in an Initial Address Message associated with the called station. Because a group call is being initiated, call redirections are not allowed, and the preselected value (e.g., five) is assigned such that if the call is redirected, thereby causing the redirection counter to be incremented, the redirection counter will exceed some maximum threshold value, and the call will be terminated. During the call setup procedure, it is determined for the called station, whether the call shall be redirected at step 38. For example, the called station might have a service activated that would cause the call to be redirected to a voice mail system or otherwise call forwarded. If not, the call is established at step 42.

On the other hand, if it is determined at step 34 that the call shall be redirected, the redirection counter is compared to the maximum redirection count threshold at step 36. As will be recognized by those of ordinary skill in the art, a determination that the call has been redirected will typically result in the redirection counter being incremented. In the case where the redirection counter and the maximum redirection count threshold both have the same value initially, incrementing the redirection counter will cause the redirection counter to exceed the maximum redirection count threshold. As a result, an attempt to set up a call that will ultimately be redirected is terminated at step 38 based on the comparison at step 36. If the redirection counter does not exceed the maximum redirection count threshold, the call is redirected at step 40. In any event, this process is repeated for each called station involved in the group call beginning at step 32.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A method for preventing call redirecting in a mobile communications network, comprising the steps of:
assigning a predetermined redirection threshold;
determining that call redirecting should not be permitted prior to establishing a call in said mobile communications network;
assigning a particular value to a redirection counter associated with said call in response to said determination that call redirecting should not be permitted;
determining whether said call shall be redirected during a setup of said call;
establishing said call if said call shall not be redirected;
comparing said particular value of said redirection counter to said predetermined threshold if said call shall be redirected; and
terminating said call in response to the comparison of said particular value and said predetermined threshold.

2. The method of claim 1, wherein said network comprises an SS7 network.

3. The method of claim 1, wherein said network comprises a D-AMPS network.

4. The method of claim 1, wherein said network comprises a GSM network.

5. the method of claim 1, wherein said network comprises a PLMN.

6. The method of claim 1, wherein the setup of said call comprises part of a setup of a group call.

7. The method of claim 6, wherein said determination that call redirecting should not be permitted is in response to a determination that the setup of said call comprises part of a setup of a group call.

8. The method of claim 6, wherein said group call comprises a plurality of calls, each of said calls having an associated redirection counter, further comprising the step of terminating each call of said plurality of calls that has been redirected.

9. The method of claim 1, wherein said redirection counter is included in an Initial Address Message.

10. The method of claim 1, wherein the step of determining whether said call has been redirected further comprises determining whether said call has been call forwarded.

11. The method of claim 1, wherein the step of determining whether said call has been redirected further comprises determining whether said call has been redirected to a voice mail system.

12. The method of claim 1, wherein the step of terminating said call is in response to said particular value being equal to or greater than said predetermined threshold.

13. A system for preventing call redirecting in a mobile communications network, comprising:
a node for storing a redirection count threshold;
at least one mobile switching center operable to:
assign a selected value to a redirection counter associated with a call in response to a determination that call redirecting should not be allowed for said call;
determine whether the call shall be redirected during a setup of the call;
establish the call if the call shall not be redirected;
compare the selected value of the redirection counter to the redirection count threshold if the call shall be redirected; and
terminate the call in response to said comparison.

14. The system of claim 13, wherein said network comprises an SS7 network.

15. The system of claim 13, wherein said network comprises a D-AMPS network.

16. The system of claim 13, wherein said network comprises a GSM network.

17. The system of claim 13, wherein said network comprises a PLMN.

18. The system of claim 13, wherein said setup of said call in said mobile communications network comprises setup of a group call.

19. The system of claim 13, wherein the redirection counter is included in an Initial Address Message.

20. The system of claim 13, wherein a first mobile switching center assigns the selected value and a second mobile switching center compares the selected value to the redirection count threshold.
